(19) United States
(12) Patent Application Publication
(10) Pub. No.: US 2009/0283480 A1
(43) Pub. Date: Nov. 19, 2009

(54) POROUS MATERIAL WITH A NONOPOROUS COATING

(75) Inventors: Volker Schadler, Maikammer (DE); Marc Fricke, Lurschau (DE); Cedric Du Fresne von Hohenesche, Mannheim (DE); Joachim Roser, Mannheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/305,465

(22) PCT Filed: Jun. 6, 2007
(86) PCT No.: PCT/EP2007/055548

§ 371 Date: Dec. 18, 2008

(30) Foreign Application Priority Data
Jun. 20, 2006 (EP) 06115723.6
Aug. 31, 2006 (EP) 06119896.6
Apr. 5, 2007 (EP) 07105727.7

(51) Int. Cl. B32B 3/26; B32B 5/22; B05D 3/10; B01D 39/08; B01D 37/00

(52) U.S. Cl. 210/767; 428/315.5; 428/315.7; 442/77; 427/245; 210/510.1; 55/524; 95/285

(57) ABSTRACT

The invention relates to a porous material comprising a substrate based on at least one organic polymer A and a coating, where
vii) the uncoated substrate based on the organic polymer A is macroporous,
viii) the surface of the macroporous substrate is coated with a polymer B based on reactive resins, and
ix) this coating with a polymer B is nanoporous and the mean diameter of the nanopores is not more than 1000 nm,
   and recording materials being excepted.

The invention also relates to a process for producing the porous material and to the use of the porous material as a filter for gases or liquids.

Finally, the invention relates to filters comprising the porous material, and to a process for filtering gases or liquids.

The invention relates to a porous material comprising a substrate based on at least one organic polymer A and a coating, where
i) the uncoated substrate based on the organic polymer A is macroporous,
ii) the surface of the macroporous substrate is coated with a polymer B based on reactive resins, and
iii) this coating with a polymer B is nanoporous and the mean diameter of the nanopores is not more than 1000 nm, and recording materials being excepted.

The invention also relates to a porous material comprising a substrate based on at least one organic polymer A and a coating, where
i) the substrate based on the at least one organic polymer A is macroporous and open-cell,
ii) the pore surface of the substrate is coated with at least one polymer B based on reactive resins, and
iii) the coating with at least one polymer B is nanoporous and the mean diameter of the nanopores is not more than 1000 nm and the mean layer thickness of the coating is less than the mean pore diameter of the uncoated substrate.

The invention also relates to a process for producing the porous material and to the use of the porous material as a filter for gases or liquids.

Finally, the invention relates to filters comprising the porous material, and to a process for filtering gases or liquids.

Filters are used for separating off solids from liquids or gases by mechanically retaining the suspended solids when the fluid phase passes through. With decreasing diameter of the filter pores, the retention capacity and hence the separation efficiency of the filter increases since solid particles of smaller diameter are also retained. However, the flow resistance of the filter also increases with decreasing filter pore diameter, measurable, for example, as the pressure drop along the filter, and the filter pores become blocked more rapidly, which reduces the filter life. In order to optimize firstly the retention capacity and secondly the pressure drop or the life, it is possible to use filters connected in series and comprising coarse filter, fine filter and, if appropriate, very fine filter, although this is more complicated in terms of apparatus.

Here, filters are also to be understood as meaning those for separating off finely divided liquids (drops, droplets) from gases, as are present in the case of aerosols or mists.

U.S. Pat. No. 5,470,612 discloses a getter for impurities which occur in optical apparatuses of satellites or in semiconductor production and are to be avoided. The getter consists of a metal net which is coated with a porous aerogel of low density. The aerogel is prepared in a sol-gel process and preferably consists of SiO₂ or resorcinol-formaldehyde or melamine-formaldehyde. Substrates other than the metal net are not mentioned.

Mahltig et al., in J. Mater. Chem. 15, 4385-4398 (2005), describe the functionalization of textiles or sieves of, for example, polyester, cotton or polyamide by coating with nanoparticles of SiO₂ or other metal oxides, the nanoparticles having been obtained in a sol-gel process. Porosities, and coatings comprising organic polymers, are not mentioned.

The non-prior-published German patent application “Papers for inkjet”, application number 102005059321.6 of Dec. 12, 2005 describes recording materials (paper) which are coated with an organic dried gel comprising, for example, phenol-aldehyde resin or amino-aldehyde resin. The gel layer is an ink receiving layer for inkjet printing and may have pores, in particular those <10 μm, for example from 10 nm to 1 μm, in diameter. The document mentions no use at all as a filter or for filtration. In this invention, recording materials are excluded.

David J. Pine and Bradley F. Chmelka of the University of California in Santa Barbara, USA, describe, in an Internet journal under the Internet address http://www.solgel.com/articles/june01/pine.asp, in the article “Hierarchically Ordered Nanoporous-Macroporous Materials”, at the end of the fourth-last paragraph, a macroporous polystyrene foam which serves as a framework for a silica/block copolymer absorbed therein. Meso/macroporous silica monoliths are obtained by consolidation and calcination.

The filter materials used to date for separating off solids from liquids or gases or separating off liquids from gases are not always satisfactory, in particular for demanding filtration tasks. In particular, the retention capacity is not satisfactory in all cases, and the pressure drop is too high or the life too short.

It was the object to remedy the disadvantages described. In particular, it was intended to provide porous materials which can be used as filters and can be produced in a simple manner. When they are used as filters, the materials should be distinguished by a good retention capacity, a small pressure drop and a long life.

According to a further object, the porous material should have a pore structure such that it is suitable as filter material for aerosols. The porous material should combine the filter properties of macroporous and nanoporous materials.

Accordingly, the porous material defined at the outset was found. A process for its production and the use of the material as a filter were also found. Furthermore, said filters comprising the material and the stated process for filtration were found. Preferred embodiments are described in the subclaims and the description. Combinations of preferred embodiments do not depart from the scope of the present invention. All pressure data are absolute pressures, unless stated otherwise.

### Macroporous Substrate

The porous material according to the invention comprises a substrate based on at least one organic polymer A, the still uncoated substrate being macroporous and the surface thereof being coated with a polymer B based on reactive resins, the coating being nanoporous and having a mean pore diameter of not more than 1000 nm, and recording materials being excepted.

In a preferred embodiment, the substrate based on at least one organic polymer A is macroporous and open-cell and the pore surface of the substrate is coated with at least one polymer B based on reactive resins, preferably starting from a gel precursor. According to this preferred embodiment, the coating is nanoporous, the mean layer thickness (number average) of the coating being less than the mean pore diameter of the uncoated substrate (volume-weighted average).

Within the context of the present invention, macroporous or macropore means that the mean diameter of the pores is more than 1 μm (1000 nm), preferably more than 10 μm, particularly preferably more than 50 μm, determined by mercury intrusion measurement according to DIN 66133. The value thus determined is a volume-weighted mean pore diameter.

In the context of this invention, macroporous preferably means that the volume-weighted mean pore diameter is more than 1 μm (1000 nm), preferably more than 10 μm, particularly preferably more than 50 μm, determined by mercury intrusion measurement according to DIN 66133.

In the context of the present invention, nanoporous or nanopore means that the mean pore diameter is not more than 1 μm (1000 nm), preferably not more than 500 nm, particularly preferably not more than 300 nm, determined by means of scanning electron microscopy and subsequent evaluation by image analysis on at least 50 pores. The mean pore diameter thus determined is a number-weighted average.

In the context of this invention, nanoporous coating means that the number-average pore diameter of the coating is not more than 1 μm (1000 nm), preferably not more than 500 nm, particularly preferably not more than 300 nm, determined by means of scanning electron microscopy and subsequent evaluation by image analysis on at least 50 pores.

The mercury intrusion measurement according to DIN 66133 is a porosimetric method and is usually effected in a porosimeter. Here, mercury is forced into a sample of the porous material. Small pores require a higher pressure in order to be filled with the mercury than large pores, and a pore size distribution can be determined from the corresponding pressure/volume diagram.

Particularly in the case of materials having low compressive strength (cf. Scherer et al., J. Non-Cryst. Solids, 1995, 186, 309-315), the BET specific surface area (Brunauer, Emmet, Teller) according to DIN 66131 can additionally be determined.

In the case of foams, open-cell means that the majority of the foam cells are not closed but are connected to one another. The volume fraction of the pores which are not connected to one another but are closed (non-open-cell or closed-cell fraction) is preferably less than 50% by volume in the case of open-cell foams. Particularly preferably, the non-open-cell volume fraction of the pores in the case of open-cell foams is not more than 30% by volume, for example not more than 20% by volume and in particular not more than 10% by volume.

In the case of the open-cell foams, mean pore diameter is preferably to be understood as meaning the mean size of the pores bounded by walls and/or struts. The determination of the mean pore diameter is effected as the volume-weighted mean value by means of mercury intrusion measurement according to DIN 66133, to which the pore diameters of the uncoated substrates stated in this invention relate.

As a substrate, i.e. before coating with the nanoporous reactive resin, suitable foams usually have a density of from 5 to 500, preferably from 10 to 300 and particularly preferably from 15 to 200 g/dm³, determined according to DIN EN ISO 845, depending on the chemical composition (see further below).

Nonwovens are products which are not woven, not knitted and not tufted and comprise fibers in which the cohesion is generally provided by the adhesion peculiar to the fibers. They may be, for example, fiber webs, spunbonded fabrics or randomized webs. Here, nonwovens are also understood as meaning bonded fiber webs and felts. Nonwovens are preferably mechanically stabilized, for example by needle punching, intermeshing or randomizing by means of sharp water or air jets. Nonwovens may also be stabilized adhesively or cohesively. Adhesively stabilized nonwovens are obtainable, for example, by adhesive bonding of the fibers with liquid binders or by melting with binder fibers which were added to the nonwoven during production. Cohesively stabilized nonwovens are, for example, by partial dissolution of the fibers with suitable chemicals and application of pressure.

Suitable nonwovens as a substrate (i.e. before coating) have, as a rule, a weight per unit area of from 10 to 2000, preferably from 50 to 1000 and in particular from 100 to 800 g/m², depending on the chemical composition.

Woven fabrics are products of crossed fibers, preferably fibers crossed at right angles. Suitable woven fabrics as a substrate (before coating) have as a rule a weight per unit area of from 10 to 2000, preferably from 30 to 1000 and in particular from 50 to 500 g/m², depending on the chemical composition.

In the case of a nonwoven or woven fabric, the mean pore diameter is preferably to be understood as meaning the mean size of the pores which result from the spaced fibers of the nonwoven or woven fabric. The determination of the mean pore diameter of the nonwovens or woven fabrics is likewise effected by mercury intrusion measurement according to DIN 66133.

The intrinsic surface area of the substrates, for example of the foam, woven fabric or nonwoven, before coating is as a rule up to 30 m²/g, for example from 1 to 20 m²/g, determined by means of gas adsorption according to the BET (Brunauer, Emmet, Teller) method according to DIN 66131.

The filter paper does not comprise recording materials, such as writing paper, drawing paper and printing paper. Suitable filter papers have as a rule a weight per unit area of from 5 to 200, preferably from 8 to 150 and in particular from 15 to 100 g/m², depending on the chemical composition.

In the context of the present invention, the surface of the substrate preferably comprises, in addition to the externally visible surface of the macroscopic body, also the internal surface of the material of the walls, struts and fibers in the substrate, provided that the corresponding surface of the material is accessible to a fluid. Accordingly, the internal region of a closed pore is not part of the surface. The pore surface includes the internal surface and the externally visible surface of the macroscopic body.

Chemically, the substrate is a substrate based on at least one organic polymer A. “Based on” or “on the basis of” means a proportion of at least 50% by weight, preferably at least 60, particularly preferably at least 70 and in particular at least 80% by weight of the substrate.

In principle, all organic polymers A which can be processed to give a foam or fibers are suitable for the substrate. The polymer A of the uncoated substrate is preferably selected from amino-aldehyde resins, phenol-aldehyde resins, polystyrene, polyvinyl chloride, polyurethanes, polyamides, polyesters, polyolefins, cellulose and fibers based on cellulose.

### Polymer A

Suitable polymers A may be synthetic or may occur in nature. They are described in more detail below.

In a first preferred embodiment, the polymer A is based on polycondensation reactive resins. Known polycondensation reactive resins comprise prepolymer compositions (precondensates) based on aromatic polyfunctional amino compounds and an aldehyde, so-called amino-aldehyde resins (aminoplasts) and those based on aromatic polyhydroxy compounds and an aldehyde, so-called phenol-aldehyde resins (phenoplasts).

Aminoplasts and phenoplasts are obtained as a rule by precondensation of a polyfunctional amino compound of a polyfunctional aromatic hydroxy compound with an aldehyde. In the precondensation, a prepolymer which still comprises reactive functional groups forms, so that, by further condensation, the polymer A in the form of a gel, a crosslinked polymer network, can form. The designation reactive resin, in particular an aminoplast or a phenoplast, thus preferably characterizes a gel precursor.

A suitable aldehyde is, for example, formaldehyde or furfural. For example, urea, benzoguanamine, melamine or aniline are suitable as the amino compound. Suitable aromatic hydroxy compounds (phenolic compounds) are, for example, the dihydroxy-benzenes (resorcinol, catechol [pyrocatechol], hydroquinone), phloroglucinol and the cresols. It is also possible to use mixtures of said monomers.

Preferred amino-aldehyde resins are those obtained from urea, benzoguanamine or melamine, and formaldehyde. Melamine-formaldehyde resins, urea-formaldehyde resins and melamine/urea-formaldehyde resins are particularly preferred. Preferred phenol-aldehyde resins are those obtained from phenol-formaldehyde and cresol-formaldehyde.

The amino-aldehyde or phenol-aldehyde resins may be unmodified or modified, for example with simple alcohols, such as methanol or ethanol. The resins are preferably water-soluble and are particularly preferably used as aqueous solutions, see further below.

The substrates based on amino-aldehyde resins and phenol-aldehyde resins are used as a rule as foams or in fiber form as woven fabrics or nonwovens. The production of such fibers and the woven fabrics or nonwovens obtainable therefrom are known. The production of the foams can start directly from the monomers or from a precondensate obtainable from them (prepolymer). The precondensate variant is preferred and is below for the particularly preferred foams based on melamine and formaldehyde by way of example.

A melamine-formaldehyde precondensate is preferably used as starting material for producing the foam. Melamine-formaldehyde condensates may comprise up to 50, preferably up to 20, % by weight of other thermosetting plastic formers in addition to melamine, and up to 50, preferably up to 20, % by weight of other aldehydes in addition to formaldehyde, incorporated in the form of condensed units. An unmodified melamine-formaldehyde condensate is particularly preferred.

Examples of suitable other thermosetting plastic formers are: alkyl- and aryl-substituted melamine, urea, urethanes, carboxamides, dicyandiamide, guanidine, sulfurylamide, sulfonamides, aliphatic amines, glycols, phenol and derivatives thereof. For example, acetaldehyde, trimethylolacetaldehyde, acrolein, benzaldehyde, furfural, glyoxal, glutaraldehyde, phthalaldehyde and terephthalaldehyde can be used as other aldehydes. Further details of melamine/formaldehyde condensates are to be found in Houben-Weyl, Methoden derorganischen Chemie, volume 14/2, 1963, pages 319 to 402.

The molar ratio of melamine to formaldehyde is as a rule from 1:1.3 to 1:3.5, in particular from 1:1.6 to 1:3.1. The melamine resins may also comprise sulfite groups incorporated in the form of condensed units, which can be effected, for example, by addition of from 1 to 20% by weight of sodium hydrogen sulfite during the condensation of the resin, cf. EP-A 37470.

The melamine-formaldehyde precondensate is usually present as a solution or dispersion and is mixed with the conventional additives required for producing a foam. Such additives are in particular emulsifiers for emulsifying the blowing agent and for stabilizing the foam, for example anionic, cationic or nonionic surfactants, e.g. alkyl sulfates, and blowing agents (chemical or physical, e.g. pentane) for producing a foam from the melamine-formaldehyde resin solution. In addition, curing agents (also referred to as catalysts) are concomitantly used; these are generally acids, e.g. formic acid or acetic acid, which catalyze further condensation of the resin to give the cured foam. The additives are homogeneously mixed with the aqueous solution or dispersion of the melamine-formaldehyde resin, for example in an extruder, it also being possible, if appropriate, to force in the blowing agent under pressure. However, it is also possible to start from a solid, e.g. spray-dried, resin and then to mix this with an aqueous solution of the emulsifier, the curing agent and the blowing agent. After the mixing, the solution or dispersion is discharged through a nozzle and then immediately heated, for example by exposure to high-frequency radiation at 2.45 GHz or to microwave radiation, and is foamed thereby. The mixture which foams owing to temperature increase and evaporation of the blowing agent is shaped, for example, into a foam strand which is cut into slabs.

Amino-aldehyde foams and phenol-aldehyde foams having a gross density of from 8 to 120, in particular from 12 to 50 g/dm³, determined according to DIN EN ISO 845, are particularly preferred.

Further information on starting materials, for example emulsifiers, blowing agents and curing agents, and further details of the process for producing the melamine-formaldehyde foam are to be found, for example, in the documents WO 01/94436, EP-A 17 671, 17 672 and 37 470.

Suitable amino-aldehyde resins or phenol-aldehyde resins as such or as a solution or dispersion are available, for example, as Kaurit®, Kauramin® or Luwipal® from BASF. Open-cell foams are also commercially available, for example the melamine-formaldehyde foam Basotect® from BASF.

If the foams produced from the polymers mentioned below are completely or predominantly closed-cell, the required open-cell character of the foam is achieved by mechanical treatment of the foam (for example opening of the cells with needles, cutting tools or sharp compressed air or water jets) or by the concomitant use of suitable blowing agents and nucleating agents which open the foam cells during foaming itself, or by means of suitable foaming conditions.

In a further preferred embodiment, the substrate is based on polystyrene. Here, polystyrene is used as an overall term and comprises homo- and copolymers of vinylaromatic monomers. Suitable monomers are styrene, α-methylstyrene, p-methylstyrene, ethylstyrene, tert-butylstyrene, vinylstyrene, vinyltoluene, 1,2-diphenylethylene, 1,1-diphenylethylene or mixtures thereof. A preferred monomer is styrene.

Polystyrene is as a rule used as foam. The production of polystyrene foams as particulate foams or extruded foams is known. In the case of particulate foams, blowing agent-containing, expandable polystyrene (EPS) is first prepared, which can be effected by the suspension process (polymerization in the presence of blowing agents), the impregnation process (impregnation of blowing agent-free polystyrene particles with the blowing agent under pressure in a heated suspension, the blowing agent diffusing into the softened particles, and cooling of the suspension under pressure) or the extrusion process (mixing of the blowing agent into a polystyrene melt by means of an extruder, discharge of the blowing agent-containing melt under pressure and subsequent underwater pressure granulation). The EPS particles are then foamed by prefoaming and final foaming to give the polystyrene foam.

Extruded polystyrene foams (XPS) are produced by mixing the blowing agent into a polystyrene melt by means of an extruder, the blowing agent-containing melt emerging directly into the environment and not being discharged under pressure. On emergence from the extruder die, the melt foams with stabilization.

In a further preferred embodiment, the substrate is based on polyvinyl chloride. For example, the homopolymers rigid PVC, obtainable by emulsion, suspension or mass polymerization of vinyl chloride, and plasticizer-comprising flexible PVC, and PVC pastes are suitable as polyvinyl chloride (PVC). Suitable vinyl chloride copolymers are those with vinyl acetate (VCVAC), with ethylene (VCE), with vinylidene chloride (VCVDC), with methyl acrylate (VCMA) or octyl acrylate, with methyl methacrylate (VCMMA), with maleic acid or maleic anhydride (VCMAH), with maleimide (VCMAI) or with acrylonitrile. Chlorinated PVC (C-PVC) is also suitable. Polyvinyl chloride also comprises polyvinylidene chlorides (PVDC), i.e. copolymers of vinylidene chloride and vinyl chloride.

Polyvinyl chloride is preferably used as foam or in fibrous form as woven fabric or nonwoven.

In a further preferred embodiment, the substrate is based on isocyanate polyadducts. A preferred embodiment of the polyadducts based on isocyanate are polyurethanes. Suitable polyurethanes may also comprise other linkages, in particular isocyanurate and/or urea linkages. Flexible, semirigid or rigid and thermoplastic or crosslinked polyurethane types are suitable as polymer A of the substrate.

The preparation of the polyurethanes has been widely described and is usually effected by reacting isocyanates I) with compounds II) reactive to isocyanates, under generally known conditions. The reaction is preferably carried out in the presence of catalysts III) and generally in the presence of assistants IV). In the case of foamed polyurethanes—which is preferred—these are prepared in the presence of conventional blowing agents V) or by known methods for the preparation of polyurethane foams.

Suitable isocyanates are, for example, 2,2′-, 2,4′- and/or 4,4′-diphenylmethane diisocyanate (MDI), 1,5-naphthylene diisocyanate (NDI), 2,4- and/or 2,6-toluene diisocyanate (TDI), 3,3′-dimethyldiphenyl diisocyanate, 1,2-diphenylethane diisocyanate and/or p-phenylene diisocyanate (PPDI), tri-, tetra-, penta-, hexa-, hepta- and/or octamethylene diisocyanate, 2-methylpentamethylene 1,5-diisocyanate, 2-ethyl-butylene 1,4-diisocyanate, pentamethylene 1,5-diisocyanate, butylene 1,4-diiso-cyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate and/or 4,4′-, 2,4′- and/or 2,2′-dicyclohexylmethane diisocyanate.

Aromatic diisocyanates, in particular 2,4- and/or 2,6-toluene diisocyanate (TDI), 2,2′-, 2,4′- and/or 4,4′-diphenylmethane diisocyanate (MDI), 1,5-naphthylene diisocyanate (NDI) and paraphenylene diisocyanate (PPDI) are preferably used. Isocyanates based on TDI or based on MDI are particularly preferably used. Oligomeric, polynuclear aromatic isocyanates based on MDI are also suitable.

For example, generally known compounds having a molecular weight of from 60 to 10 000 and a functionality with respect to isocyanates of from 1 to 8, preferably from 2 to 6, can be used as compounds II) reactive toward isocyanates. Suitable compounds II) are, for example, polyols, in particular those having a molecular weight of from 500 to 10 000, e.g. polyether polyols, polyester polyols, polyether polyester polyols, and/or diols, triols and/or polyols having molecular weights of less than 500.

If appropriate, generally known compounds which accelerate the reaction of isocyanates with the compounds reactive toward isocyanates can be used as catalysts III) for the preparation of the polyurethanes, preferably a total catalyst content of from 0.001 to 15% by weight, in particular from 0.05 to 6% by weight, based on the weight used altogether of compounds II) reactive toward isocyanates, being used, for example tertiary amines and/or metal salts, for example inorganic and/or organic compounds of iron, of lead, of zinc and/or of tin in conventional oxidation states of the metal.

If appropriate, conventional substances may be used as assistants IV). Surface-active substances, fillers, dyes, pigments, flameproofing agents, hydrolysis stabilizers, fungistatic and bacteriostatic substances and UV stabilizers and antioxidants may be mentioned by way of example.

The person skilled in the art can find details relating to polyurethanes, polyisocyanurates and polyureas in Kunststoff-Handbuch, 3rd edition, volume 7 “Polyurethanes”, HanserVerlag, Munich 1993.

Polyurethanes are preferably used in the form of foam.

In a further preferred embodiment, the substrate is based on polyamides. Suitable polyamides (PA) are those having an aliphatic semicrystalline or partly aromatic and amorphous composition of any type and blends thereof, including polyetheramides, such as polyether block amides. In the context of the present invention, polyamides are to be understood as meaning all known polyamides. Such polyamides generally have a viscosity number from 90 to 350, preferably from 110 to 240 ml/g, determined in a 0.5% strength by weight solution in 96% strength by weight sulfuric acid at 25° C. according to ISO 307.

The examples of suitable polyamides are (the monomers are stated in brackets):

| | |
|---|---|
| PA 46 | (tetramethylenediamine, adipic acid) |
| PA 66 | (hexamethylenediamine, adipic acid) |
| PA 69 | (hexamethylenediamine, azelaic acid) |
| PA 610 | (hexamethylenediamine, sebacic acid) |
| PA 612 | (hexamethylenediamine, decanedicarboxylic acid) |
| PA 613 | (hexamethylenediamine, undecanedicarboxylic acid) |
| PA 1212 | (1,12-dodecanediamine, decanedicarboxylic acid) |
| PA 1213 | (1,12-dodecanediamine, undecanedicarboxylic acid) |
| PA 1313 | (1,13-diaminotridecane, undecanedicarboxylic acid) |
| PA MXD6 | (m-xylylenediamine, adipic acid) |
| PA TMDT | (trimethylhexamethylenediamine, terephthalic acid) |
| PA 4 | (pyrrolidone) |
| PA 6 | (ε-caprolactam) |
| PA 7 | (ethanolactam) |
| PA 8 | (capryllactam) |
| PA 9 | (9-aminopelargonic acid) |
| PA 11 | (11-aminoundecanoic acid) |
| PA 12 | (laurolactam) |
| PA 6T | (hexamethylenediamine, terephthalic acid) |
| PA 6I | (hexamethylenediamine, isophthalic acid) |
| PA 6/6TPA | (caprolactam/hexamethylenediamine, terephthalic acid) |
| PA 6-3-T | (trimethylhexamethylenediamine, terephthalic acid) |

PA 6 and PA 66 are preferred. Said polyamides and their preparation are known. Corresponding polyamides are obtainable, for example, under the trade name Ultramid® from BASF.

Polyamides are preferably used in fibrous form, i.e. as woven fabric or nonwoven.

In a further preferred embodiment, the substrate is based on polyesters. Suitable polyesters comprise an aromatic ring in the main chain, which originates from an aromatic dicarboxylic acid. The aromatic ring may also be substituted, for example by halogen, such as chlorine and bromine, or by C₁-C₄-alkyl groups, such as methyl, ethyl, isopropyl or n-propyl and n-butyl, isobutyl or tert-butyl groups. The polyesters can be prepared by reacting aromatic dicarboxylic acids, esters thereof or other ester-forming derivatives thereof with aliphatic dihydroxy compounds in a manner known per se.

Preferred dicarboxylic acids are naphthalenedicarboxylic acid, terephthalic acid and isophthalic acid or mixtures thereof. Up to 10 mol % of the aromatic dicarboxylic acids may be replaced by aliphatic or cycloaliphatic dicarboxylic acids, such as adipic acid, azelaic acid, sebacic acid, dodecanedioic acids and cyclohexanedicarboxylic acids. Of the aliphatic dihydroxy compounds, diols having 2 to 6 carbon atoms, in particular 1,2-ethanediol, 1,4-butanediol, 1,6-hexanediol, 1,4-hexanediol, 1,4-cyclohexanediol and neopentyl glycol or mixtures thereof, are preferred.

Particularly preferred polyesters are polyalkylene terephthalates which are derived from alkanediols having 2 to 6 carbon atoms. Of these, polyethylene terephthalate (PET), polyethylene naphthalate (PEN) and polybutylene terephthalate (PBT) are particularly preferred. Polytetrahydrofuran (PolyTHF) is also a suitable polyester.

Polyesters are preferably used in the form of fibers, i.e. as woven fabric or nonwoven.

In a further preferred embodiment, the substrate is based on polyolefins. Suitable polyolefins are, for example, homo- and copolymers comprising ethylene, propylene, but-1-ene, isobutylene, 4-methylpentene and/or hex-1-ene. Polyethylene (PE) and polypropylene (PP) are preferred. Polybutenes, such as polybut-1-ene and polyisobutylene (PIB) can also be used.

Suitable polyethylenes are, for example, ULDPE (ULD ultra low density), LDPE (LD low density), LLDPE (LLD linear low density), HDPE (HD high density), HMWPE (also referred to as HD-HMWPE, HMW high molecular weight) and UHMWPE (also referred to as HD-UHMWPE, UHMW ultra high molecular weight). Crosslinked polyethylenes (XPE), and chlorinated and chlorosulfonated polyethylenes (CPE) are also suitable, as are ethylene-vinyl acetate copolymers (EVA), ethylene-vinyl alcohol copolymers (EVAL) and copolymers of ethylene with ethyl acrylate (EEA), butyl acrylate (EBA), methyl acrylate (EMA), acrylic acid (EM) or methacrylic acid (EMM). Furthermore, it is also possible to use ethylene-norbornene copolymers, which are also referred to as cycloolefin copolymers (COC). Such polyethylenes and their preparation are known.

Suitable polypropylenes are, for example, homopolypropylene or copolymers of propylene with comonomers, in particular C₂₋₈-alkenes such as ethylene, but-1-ene, pent-1-ene or hex-1-ene. The copolymers may be random copolymers, block copolymers or impact copolymers, and the comonomer fraction is as a rule up to 50% by weight. The random copolymers usually comprise up to 15, preferably up to 6, % by weight of other alk-1-enes, such as ethylene, but-1-ene or mixtures thereof.

In the case of the likewise suitable block or impact copolymers of propylene, a propylene homopolymer or a copolymer of propylene with up to 15, preferably up to 6, % by weight of said alk-1-enes is prepared in a first stage, and polymerization is effected in a second stage to give a propylene-ethylene copolymer having an ethylene content of from 15 to 80% by weight, it being possible for the propylene-ethylene copolymer to additionally comprise further C₄₋₈-alkenes. Usually, the proportion of block or impact copolymer in the second stage is from 3 to 60% by weight. Like the polyethylenes, the polypropylenes too may be chlorinated (CPP). Ethylene-propylene copolymers (EPM) or ethylene-propylene-diene copolymers (EPDM) are also suitable.

Said polyolefins are known. They can be prepared, for example, by means of Ziegler-Natta or metallocene catalyst systems and are commercially available.

Polyolefins can be used in the form of foam or in fibrous form as woven fabric or nonwoven. The polyolefin foams are produced, for example, as described further above in the case of the polystyrene foaming processes.

In a further preferred embodiment, the substrate is based on cellulose. Cellulose is preferably used in fibrous form, in particular as woven fabric or nonwoven. Suitable fibers based on cellulose are cotton, pulp, kapok, linen, ramie, jute, hemp, coconut fibers, sisal and all other cellulose-containing natural fibers, and fibers based on regenerated cellulose or cellulose esters, such as rayon, cupram monium rayon, cellophane, viscose, cellulose acetate or acetate rayon. Pulp is particularly preferred.

The production of such woven fabrics and nonwovens based on cellulose is known.

In a preferred embodiment, the uncoated substrate is selected from foams based on amino-aldehyde resins, phenol-aldehyde resins and polyurethanes.

In an embodiment which is likewise preferred, the uncoated substrate is selected from woven fabrics or nonwovens based on polyesters or cellulose.

Coating with Polymer B

According to the invention, the surface of the macroporous substrate is coated with a polymer B based on reactive resins, and this coating is nanoporous, the mean diameter of the nanopores being not more than 1000 nm, determined by mercury intrusion measurement according to DIN 66133.

The term “based on” comprises both the respective compound or the respective compounds in reacted or unreacted form, i.e. the term can relate both to a gel precursor and to a crosslinked polymer. “Based on” means as a rule a proportion of at least 50% by weight, preferably at least 60, particularly preferably at least 70 and in particular at least 80% by weight, of reactive resin, based on cured polymer B.

The reactive resins are composed of low molecular weight organic compounds or of precondensates which can undergo a crosslinking reaction, for example by addition or condensation reactions. In the context of this invention, the term reactive resin preferably comprises both monomeric starting materials and prepolymers, i.e. monomers which have been reacted beforehand. The reactive resins are preferably gel precursors. A gel precursor is a composition comprising at least one monomeric and/or prepolymerized compound which is gelable and which can be reacted by a crosslinking reaction in the presence of solvent to give a gel.

The preparation of nanoporous polymers starting from reactive resins, preferably gel precursors, is widely known. Usually, the preparation is effected by the sol-gel process, a reactive precursor first being provided, which is then converted into a gel. Thereafter, the solvent is removed, usually after it has been exchanged for an alternative solvent. In principle, all known gel precursors which can be converted to a gel by the process described above are suitable as a precursor of polymer B.

The reactive resin is preferably selected from amino-aldehyde resins (aminoplasts), phenol-aldehyde resins (phenoplasts) and gel precursors based on isocyanates. Of these, the amino-aldehyde resins and the gel precursors based on isocyanates are particularly preferred. Among the amino-aldehyde resins, urea-formaldehyde resins and melamine-formaldehyde resins are particularly preferred.

The reactive resin is particularly preferably selected from melamine-formaldehyde resins, urea-formaldehyde resins, melamine/urea-formaldehyde resins and gel precursors based on isocyanates and phenols. Among the gel precursors based on isocyanates and phenols, gel precursors based on polyfunctional aromatic isocyanates and phenols having at least two hydroxyl groups per molecule are very particularly preferred.

Amino-aldehyde resins and phenol-aldehyde resins suitable as precursors of polymer B have already been described further above in the case of the nanoporous substrate (polymers A). The thermosetting plastic formers mentioned there in the case of the production of melamine-formaldehyde foams, described by way of example, or other aldehydes can also be concomitantly used.

The amino-aldehyde resins and phenol-aldehyde resins are preferably water-soluble.

The resins may be unmodified or modified with alcohols and thus made hydrophobic.

As precursor of polymer B very particularly preferred reactive resins are melamine-formaldehyde resins, preferably those having a molar ratio of melamine to formaldehyde of from 1:1.2 to 1:3.5, preferably from 1:1.4 to 1:2, in particular from 1:1.4 to 1:1.6.

Suitable amino-aldehyde resins or phenol-aldehyde resins as such or as a solution or dispersion are available, for example, as Kaurit®, Kauramin® or Luwipal® from BASF.

Suitable reactive resins based on isocyanates are those comprising the following components: (I) at least one isocyanate having a functionality of at least 2 and (II) at least one compound reactive toward isocyanates and having a functionality of at least 2. The reaction of the components (I) and (II) is preferably carried out in the presence of catalysts (III).

In the context of the present invention, functionality of a compound is understood as meaning the number of reactive groups per molecule. The functionality reflects the number of isocyanate groups or the number of groups reactive toward isocyanates per molecule.

Starting from reactive resins based on isocyanates, polyadducts can be prepared as polymer B in the form of a nanoporous coating, as described further below. Usually, this preparation is effected by a sol-gel process in the presence of solvent or dispersant, which is removed after the crosslinking (gelling) of the reactive resin. The polymer B based on polyadducts of isocyanates may comprise isocyanurate, urea or urethane linkages or two or three of these linkages.

Suitable isocyanates are, for example, the aliphatic, cycloaliphatic and aromatic diisocyanates described under polymer A. Aromatic diisocyanates, in particular 2,4- and/or 2,6-toluene diisocyanate (TDI), 2,2′-, 2,4′- and/or 4,4′-diphenylmethane diisocyanate (MDI), 1,5-naphthylene diisocyanate (NDI) and paraphenylene diisocyanate (PPDI), are preferably used as the isocyanate. Isocyanates based on TDI or based on MDI are particularly preferably used.

Suitable isocyanates are in particular so-called oligomeric isocyanates. These are oligomeric or polymeric condensates and therefore derivatives of aromatic monomeric diisocyanates. They are preferably oligomeric aromatic isocyanates based on MDI. The isocyanates can also be used as mixtures of monomeric and oligomeric isocyanates.

An oligomer of MDI is a polynuclear condensate of MDI having a functionality of more than 2, preferably 3, 4 or 5. Oligomeric MDI is known and usually comprises a mixture of MDI-based isocyanates having different functionalities. Usually, the oligomeric MDI thus used also comprises a significant proportion of monomeric MDI. The (average) functionality of the mixed oligomeric MDI may vary in the range from about 2.5 to about 5, for example from 2.7 to 3.5. Such a mixture of MDI-based isocyanates having different functionalities is, for example, crude MDI, which is obtained in the preparation of MDI.

The described isocyanates or mixtures of a plurality of isocyanates based on MDI are known and are sold, for example, by Elastogran GmbH under the name Lupranat®.

Suitable compounds reactive toward isocyanates are known in principle to the person skilled in the art in relation to nanoporous polymer foams which were prepared by a sol-gel process.

In particular, the following compounds, individually or as a mixture, are suitable as compounds reactive toward isocyanates for the production of the nanoporous coating:
polyoxyalkyleneamines or amine-based polyols or mixtures thereof, as described in US-A 2006/0211840 in paragraphs [0009] and [0014], or alkoxylated compounds having a higher functionality and reactive toward isocyanate, as described in WO 95/03358 on page 8, fourth to last paragraph;
polyesterols, polyetherols and/or polycarbonatediols, which are usually also summarized by the term “polyols” having molecular weights from 500 to 12 000 g/mol, preferably from 600 to 6000, in particular from 800 to 4000, and an average functionality of about 2 to about 5;
polyetherpolyalcohols, polyesterpolyalcohols, polyetherpolyesteralcohols, polythioetherpolyols, polyacetals containing hydroxyl groups and aliphatic polycarbonates containing hydroxyl groups or mixtures of at least two of said polyols;
hyperbranched compounds, for example highly branched polyols comprising ester groups, for example the condensates obtainable from 2,2-dimethylol-propionic acid, which Perstorp AB markets under the brands Boltorn®, as described in WO 2006/128872;
phenolic compounds having at least two hydroxyl groups, for example derivatives of benzenediol, such as catechol (1,2-dihydroxybenzene), resorcinol (1,3-dihydroxybenzene), hydroquinone (1,4-dihydroxybenzene) or orcinol (3,5-dihydroxytoluene). Furthermore, phenolic compounds having at least 2 benzene rings, in particular derivatives of bisphenyl, for example 4, 4′-biphenol or bisphenol A, are suitable. In addition, phenolic compounds having an OH functionality of three are suitable, for example pyrogallol and in particular phloroglucinol. Phenolic compounds having an OH functionality of three, in particular phloroglucinol, are particularly suitable as the phenolic compound.

Starting from said amino-aldehyde resins, phenol-aldehyde resins and gel precursors based on isocyanates, however, a distinction is made between the process for the production of the nanoporous coating and the process for the production of the substrate, as will be further explained further below. While the substrate is produced starting from said reactive resins, usually by using blowing agents, the production of the nanoporous coating is effected starting from the reactive resins described, usually by a sol-gel process.

Depending on the intended use of the porous material according to the invention and on the desired property profile, the polymers A of the uncoated macroporous substrate and the polymers B of the nanoporous coating may be identical in chemical nature (example: melamine-formaldehyde coating on melamine-formaldehyde foam) or different in chemical nature (example: melamine-formaldehyde coating on cellulose nonwoven or on polyester woven fabric).

The invention also relates to a process for producing the porous material according to the invention, wherein the reactive resin is brought into contact with the macroporous uncoated substrate and then cured in the presence thereof to polymer B.

In a preferred embodiment, this process comprises the following steps:
a) the reactive resin as precursor of polymer B is provided as a solution or dispersion in a liquid
b) a catalyst is added to the solution or dispersion obtained in step a)
c) the macroporous uncoated substrate is brought into contact with the mixture obtained in step b)
d) the mixture brought into contact with the substrate in step c) is cured in the presence of the substrate
e) the liquid present in the mixture is removed.

The process is preferably carried out in the sequence a-b-c-d-e. If the curing takes place rapidly, the sequence a-c-b-d-e is also possible as an alternative. In a further embodiment, the addition of the catalyst is optional and the process is carried out according to the sequence a-b (optionally)-c-d-e or a-c-b (optionally)-d-e.

In step a), the reactive resin as gel precursor of polymer B is provided as a solution or dispersion in a liquid.

In the case of the amino-aldehyde resins and of the phenol-aldehyde resins, the reactive resin used in step a) is preferably a precondensate (prepolymer). It is possible to use, for example, a solution or dispersion as obtained directly in the preparation of the precondensate or to dilute such a solution or dispersion with the liquid until the desired content of the solution or dispersion is present. It is also possible to start from a solid, e.g. spray-dried, reactive resin and to mix this with the liquid so that the solution or dispersion is obtained.

If a gel precursor based on isocyanates is used as reactive resin in step a), the two components isocyanate I) and compounds II) reactive with isocyanate are preferably provided separately from one another as a solution or dispersion. As described further below in the case of step b), in the case of the polyurethanes the catalyst is preferably added to one of the components and the other component is added only thereafter.

The liquids preferably used as solvents or dispersants in step a) are water in the case of the amino-aldehyde resins and phenol-aldehyde resins as gel precursor of polymer B and, if gel precursors based on polyisocyanates or hydrophobic reactive resins are used, organic solvents, for example those which are usually used in the preparation of polyurethanes. It is preferable to start from an aqueous amino-aldehyde or phenol-aldehyde resin solution or dispersion.

The layer thickness, density and mechanical stability of the coating with polymer B can be controlled, inter alia, via the concentration of the reactive resin in the solvent or dispersant. The concentration of the reactive resin in the solvent or in the dispersion must not be chosen too low, since otherwise no coating at all, no mechanically stable coating or no coating sufficiently stable for the requirements is obtained on curing (gelling). Solutions or dispersions whose content of reactive resin is at least 0.5 and in particular at least 1% by weight are preferably used.

In the case of porous materials according to the invention which have high filter efficiency, which are subject to high mechanical stress, for example in the case of a high flow rate and/or high solids content of the medium to be filtered, or if abrasive solids are to be separated off or if a particularly long life of the filter is desired, a particularly stable nanoporous coating with high mechanical stability may be advantageous. This is obtained using higher reactive resin contents of, for example, at least 5% by weight, based on the reactive resin solution or dispersion, with the result that a mechanically sufficiently stable coating forms.

The maximum content of the reactive resin solution or dispersion depends, on the one hand, on the viscosity of the solution or dispersion. The solution or dispersion should have such a low viscosity that it reaches all desired surfaces of the substrate when brought into contact with the uncoated substrate. Thus, for example in the case of foam bodies as substrate, it is preferred that at least parts of the interior of the foam also have a nanoporous coating, for which purpose the reactive resin solution or dispersion must penetrate into the interior of the foam body.

Owing to the fact that coating of the substrate is to be achieved, the mean layer thickness of the coating preferably being less than the mean pore diameter of the substrate, there is on the other hand an upper limit for the content of reactive resin in the solvent or dispersant. This means that the concentration of the reactive resin solution is preferably chosen to be lower than a concentration which leads to complete or virtually complete filling of the pores of the substrate.

Preferably, the concentration of the reactive resin in the solvent is not more than 10% by weight, for example from 0.5 to 10% by weight. A concentration of the reactive resin in the solvent of from 1 to 8% by weight, in particular from 2 to 7% by weight, is particularly preferred.

Temperature and pressure in step a) are usually not critical and are, for example, from 0 to 150° C., preferably from 10 to 100° C. and from 0.8 to 50, preferably from 1 to 20, bar, respectively.

In step b), a catalyst is added to the solution or dispersion obtained in step a). Organic acids, for example carboxylic acids having 1 to 6 carbon atoms, are suitable as the catalyst for the amino-aldehyde resins or phenol-aldehyde resins. Formic acid and acetic acid are preferred. Likewise preferred are inorganic acids, in particular mineral acids, such as sulfuric acid, nitric acid, phosphoric acid or hydrohalic acids, e.g. hydrochloric acid.

For example, the customary catalysts mentioned further above in the description of the polyurethanes as component III), e.g. tertiary amines or metal salts, are suitable as the catalyst for polyurethanes. It has proven advantageous in the case of polyurethanes as polymer B, to provide the components isocyanate 1) and compounds II) reactive toward isocyanates (polyols, etc.) separately from one another, to add the catalyst III) to one of the two components I) and II), to mix thoroughly and only thereafter to add the other component. Particularly preferably, the catalyst II) is mixed with the component II) reactive toward isocyanates, and the isocyanate component 1) is then added.

The catalyst can be added as such or in solution in a solvent. This solvent is preferably identical to the liquid which is used in step a) in the provision of the reactive resin solution or dispersion. The catalyst is as a rule mixed with the reactive resin solution or dispersion with stirring.

In a further preferred embodiment, one or more carbonates are added to the catalyst. Suitable carbonates are, for example, carbonates of alkali metals and alkaline earth metals. The bicarbonates of the relevant metals are also suitable. However, the addition of carbonates of the alkali metals and alkaline earth metals, is preferred, particularly preferably calcium carbonate. The addition of carbonates to the catalyst is particularly advantageous if an organic or inorganic acid is used as a catalyst, as in the preparation of amino-aldehyde resins or phenol-aldehyde resins. Preferably, a proportion of from 0.5 to 15% by weight carbonate, based on the catalyst in pure substance, are added to the catalyst. Particularly preferably 1 to 8% by weight of the carbonate, in particular calcium carbonate, are added. By the addition of the carbonate, in particular the calcium carbonate, the pore size distribution of the materials according to the invention can be varied.

Temperature and pressure in step b) are as a rule not critical and are, for example, from 10 to 150° C., preferably from 20 to 100° C. and from 0.8 to 50, preferably from 1 to 10, bar, respectively.

In step c), the macroporous uncoated substrate is brought into contact with the mixture obtained in step b). The bringing into contact can be designed in such a way (variant 1) that only the outer surface of the substrate is wetted with the reactive resin/catalyst mixture, but not the “inner” surface, i.e. the macropores in the interior of the substrate. It is also possible for substrate and the mixture to be brought into contact with one another (variant 2) so that the inner substrate surface, too, is wetted, for example by allowing the mixture to pass partly or completely through the porous substrate. Variant 2, wetting of the internal surface, is preferred and may be advantageous, for example, in the case of filters for demanding filtration tasks.

Particularly in the case of variant 1, wetting of the outer substrate surface, the bringing into contact can be effected by applying the mixture to the uncoated substrate by spraying, brushing, roller-coating with a fur-covered roller, roller-coating with a hard roller, casting or knife-coating or by other conventional methods. These methods are suitable in particular for thin substrates which tend to be sheet-like, such as woven fabrics, nonwovens or filter papers. In the case of sheet-like substrates, one or both sides may be wetted, with the result that a spatially heterogeneous distribution of the nanoporous coating is subsequently obtained.

For example, immersing the substrate in the mixture or repeating the wetting method mentioned in the case of variant 1 several times so that the mixture can penetrate into the macropores of the substrate interior is suitable for the preferred variant 2. Depending on the dimensions and the characteristics (permeability, pore size distribution, degree of open-cell character) of the substrate and on the viscosity of the mixture, a certain time may be required for the immersion, for example from 1 sec to 6 hours. Substrates having small dimensions (small volume with large surface area) and good permeability and low-viscosity mixtures facilitate the penetration; this results in a shorter duration of immersion or bringing into contact in another manner.

Preferably, in the process according to the invention, the bringing into contact in step c) is effected by immersion of the uncoated substrate in the mixture. Immersion is suitable in particular for thick sheet-like substrates and for bulky substrates, for example for thick woven fabrics and nonwovens and for all open-cell foams.

If required, it is possible to work at elevated temperature in step c) in order to reduce the viscosity of the mixture and in this way to facilitate the wetting or penetration of the substrate. Usually, the procedure is effected at from 20 to 100° C., preferably from 25 to 80° C. Particularly in the case of variant 2, the penetration can also be facilitated by working under pressure, with the result that the mixture is forced into the interior of the substrate. As a rule, the pressure is from 0.8 to 50, preferably from 1 to 10, bar.

In order to remove air present in the macropores of the substrate and thus to facilitate the penetration of the mixture into the substrate interior, the substrate can be “vented” under reduced pressure before being brought into contact, or the immersed substrate can be treated with ultrasound or, if the substrate is elastic and has sufficient resilience, the air can also be removed mechanically by compression or tumbling.

If the substrate is brought into contact with the mixture by immersion, it can be removed from the mixture subsequently, for example after penetration, before it is cured in step d). The substrate preferably remains immersed during curing.

In step d), the mixture applied to the substrate in step c) is cured. It is thought that the curing of the mixture results in a nanoporous gel whose nanopores are still filled with liquid—namely the liquid used in step a), preferably water.

The curing is usually effected by allowing the coated substrate to stand, for example by allowing the woven fabric or nonwoven sprayed with the mixture to stand, or by allowing a foam, woven fabric or nonwoven immersed in the mixture to stand. In the case of substrates immersed in the mixture, the mixture is preferably not stirred or otherwise mixed during the curing of the mixture, because this could hinder the formation of the gel. It has proven advantageous to cover the mixture during the curing (gelling) or to close the immersion container.

The temperature in step d) is, for example, from 10 to 150° C., preferably from 20 to 100° C. and in particular from 25 to 80° C. In the simplest case, curing can be effected by allowing to stand at room temperature (20° C.). Depending on reactive resin B used, the curing can be accelerated by higher temperatures. For example, coatings of amino-aldehyde resins, such as melamine-formaldehyde, can be cured at from 40 to 90° C., preferably from 50 to 80° C.

The pressure in step d) is as a rule not critical and is, for example, from 0.8 to 50, preferably from 1 to 10, bar.

The duration of curing depends, inter alia, on the size, shape and porosity of the substrate, the amount of mixture applied, its content of monomers or precondensate and catalyst, and the temperature and may vary within wide limits, for example from 1 sec to 48 hours, in particular from 1 min to 12 hours and particularly preferably from 5 min to 6 hours. The person skilled in the art determines the duration of curing in a few preliminary experiments which can be easily carried out, without a substrate.

The gel forming during curing has a substantially higher viscosity than the (usually low-viscosity) mixture prior to curing. The curing can consequently be monitored by an increase in viscosity and is complete when the viscosity of the applied mixture does not increase any further.

In step e), the liquid present in the applied mixture is removed, i.e. the gel obtained in step d) is dried.

The temperature and pressure conditions during removal of the liquid depend on the type of liquid and on the liquid content in the cured mixture (the gel). For example, the liquid can be removed at a temperature of from −5 to 150° C., preferably from 0 to 120° C., and a pressure of from 0.001 to 10, preferably from 0.01 to 1, bar. If the liquid is water, as is preferred, the water is removed from the water-containing gel, for example, at temperatures of from 0 to 150° C., preferably from 10 to 120° C. and particularly preferably from 15 to 100° C., and at pressures of from high vacuum (10⁻⁷ mbar) to, for example, 10 bar, preferably from 1 mbar to 10 bar and in particular from 10 mbar to 5 bar. For example, drying may be effected at a pressure of from 0.5 to 2 bar and at a temperature of from 0 to 100° C. Particularly preferably, drying is effected at atmospheric pressure and from 0 to 80° C., in particular at room temperature.

For removal of the liquid, covers or container lids used, if appropriate, during the curing are removed and said pressure and temperature conditions are maintained until the liquid has been removed by transition into the gaseous state, i.e. the liquid is evaporated (vaporized).

Drying may be effected in the air or, if the mixture is oxygen-sensitive, also in other gases, such as nitrogen or noble gases, and, if appropriate, a drying oven or other suitable apparatuses may be used for this purpose.

The drying can be accelerated or completed by application of reduced pressure. In order to further improve the drying effect, this drying under reduced pressure can be carried out at a higher temperature than the drying at customary pressure. For example, the major part of the water can first be removed at room temperature and atmospheric pressure in the course of, for example, from 8 to 12 days and the remaining water can then be removed at from 40 to 80° C. under a reduced pressure of, for example, from 1 to 100, in particular from 10 to 30, mbar in the course of from 1 to 5 days.

Instead of such stepwise drying, the pressure may also be reduced continuously, for example linearly or exponentially, during the drying, or the temperature may be increased in such a manner, i.e. drying may be effected along the pressure or temperature program.

Of course, the lower the moisture content of the air, the more rapidly the mixture dries. The drying can also be accelerated by circulating and/or exchanging the ambient air. The same applies in context to liquid phases other than water and to gases other than air.

During the drying in step e), the liquid is as a rule removed completely or to a residual content of from 0.01 to 1% by weight, based on the final, nanoporous reactive resin polymer layer.

Alternatively or additionally to the use of the catalyst, the curing can also be carried out thermally. Properties and use of the porous material

The structural aspects of the substrate on which the porous material is based were explained further above. According to the invention, the surface of the macroporous substrate is coated with a polymer B based on reactive resins.

Coating is preferably to be understood as meaning the presence of a mass of cured reactive resin in sheet-like form on the struts, walls and/or fibers of the substrate. A coating is preferably a substrate surface partly or completely covered with the coating material; particularly preferably, the pore surface of the substrate (i.e. the internal and external surface) is completely or partly covered with the coating material. The term “covered” excludes complete filling of the macropores.

Preferably, the pore surface of the substrate is covered to a proportion of at least 10% of the total pore surface of the substrate, preferably to at least 30%, in particular to at least 50%, with the coating material.

The proportion of the coated pore surface (the degree of covering) and the mean layer thickness are determined by means of scanning electron microscopy and image analysis methods. It should be ensured that at least 20 individual determinations are effected in order to obtain a statistically meaningful mean value.

The mean layer thickness, determined as the number-weighted average by scanning electron microscopy and image analysis of at least 20 individual measurements is preferably less than the mean pore diameter of the substrate, determined as the volume-weighted mean value by means of mercury intrusion measurement according to DIN 66133. Accordingly, owing to the macropores of the substrate and the nanopores of the coating, the porous material is preferably both macroporous and nanoporous.

The thickness of the final, nanoporous reactive resin polymer layer as obtained after removal of the liquid (step e) is as a rule from 0.01 to 10, preferably from 0.05 to 1 and in particular from 0.1 to 0.9 μm.

If desired, the processes described can be repeated once or several times and a second or further nanoporous polymer layer can be applied in this way. The reactive resins B of the individual nanoporous layers may be identical or different.

In the material according to the invention, the nanoporous coating with polymer B may line the macropores of the substrate uniformly or irregularly or may cover the webs, fibers and/or walls of the macropores completely or incompletely. It is also possible for macropores to be present in which the reactive resin has collected at the bottom prior to curing and which are partly filled with the cured reactive resin in the material according to the invention. However, a porous material whose macropores are not completely filled with cured reactive resin and in which a coating in the sense described above is therefore present is preferred.

As mentioned at the outset, the mean diameter of the pores in the nanoporous coating is not more than 1000 nm, preferably not more than 500 nm. It is also preferably at least 1 nm, particularly preferably at least 10 nm. The mean diameter of the pores in the nanoporous coating is preferably a number average diameter which is determined by scanning electron microscopy.

If the material has two or more nanoporous reactive resin coatings, the thicknesses and pore diameters of the individual layers may differ.

In structural terms, the porous material according to the invention (i.e. the coated substrate) is preferably an open-cell form, a woven fabric, a nonwoven or a filter paper, i.e. the porous material according to the invention at least partly retains the open-cell structure of the substrate. Particularly preferably, the porous material according to the invention is an open-cell foam or a nonwoven, in particular an open-cell foam.

The porous material according to the invention, for example the foam, the woven fabric, the nonwoven or the filter paper, may be hard, firm, rigid, flexible, pliant, soft or resilient and may or may not have elastic properties.

The porous material according to the invention, comprising macroporous substrate and nanoporous reactive resin layer, is distinguished by at least one, preferably at least two, in particular all four, of the following properties, very particularly preferably at least the properties 3) and 4) being fulfilled:
1) A large intrinsic surface area. It is as a rule at least 10, preferably at least 20 and particularly preferably at least 50 m²/g, determined by means of gas adsorption by the BET (Brunauer, Emmet, Teller)—method according to DIN 66131.
2) A low density. It is usually not more than 300, preferably not more than 200 and in particular not more than 100 g/dm³.
3) The pore size distribution over all pores (nanopores and macropores) is bimodal. The pore size distribution is preferably broad so that both nanopores and macropores are present.
4) The pore size distribution over all pores (nanopores and macropores), determined by means of mercury intrusion measurement as described at the outset, is such that usually from 1 to 60, preferably from 2 to 50 and particularly preferably from 3 to 40% by volume of the pores have a diameter of not more than 1 μm (1000 nm).

Owing to these properties, the material according to the invention can be used for various purposes. In particular owing to the large intrinsic surface area, the materials according to the invention have a high filter efficiency.

Preferred and likewise the subject of the invention is the use of the material as a filter for gases or liquids. “Gases” or “liquids” designate the fluid phase in which solids (if appropriate to be filtered off) can be dispersed. In the case of gases, liquids or aerosol particles can also be filtered off.

Preferred uses are those as filters in the air conditioning of buildings, for example on air conditioning systems and in the purification of fresh air (inlet air) or waste air in buildings or rooms, for example residential buildings, administrative buildings, industrial buildings or storage buildings,
in the waste gas purification of industrial plants and power stations,
in the exhaust gas purification of vehicles,
in vehicle air conditioning systems,
in the purification of waste air in industries with high dust emission, for example textile trade, building material industry, pigment industry, wood processing, furniture industry, and in the transport, treatment and processing of coal, rock salt, minerals, ores or other mineral resources,
in the purification of inlet air for very clean rooms, for example in semiconductor production or chemical trace analysis,
in the purification of inlet air in the production of medicaments or medical products,
in the purification of inlet air or waste air in hospitals, for example isolation wards, or in research facilities, for example chemical, bacteriological or virological laboratories or pilot plants,
in the filtration of suspensions or solid/liquid mixtures of all kinds, for example in chemistry, chemical technology, biology, biochemistry, biotechnology, genetic engineering, molecular biology, food technology,
in the purification of liquids and gases of all kinds to remove undesired solids,
in the purification, treatment or preparation of water, for example drinking water or wastewater,
for the separation of liquid droplets from gases, for example aerosols or spray mists in paint shops and spray booths,
in respiratory masks, protective masks and respirators,
in the area of nanotechnology.

These may be uses on the laboratory scale, on the pilot scale or in industrial production.

The solids retained by the filter may be, for example, organic or inorganic particles, dust, fine dust, fibers, nanoparticles, bacteria, viruses, spores (e.g. from fungi, algae, lichens or bacteria of all kinds).

The retained solid may be undesired, for example, dust in air conditioning systems or pathogenic bacteria in hospitals, or may be a desired product which is to be separated off, for example a previously precipitated solid in chemistry. The same applies in context to retained liquids.

The invention also relates to filters comprising the porous material described above and to a process for filtering gases or liquids, wherein the material according to the invention or a filter according to the invention is concomitantly used.

The porous materials according to the invention can be used in a variety of ways as a filter. They can be produced in a simple manner and, when used as a filter, have a good retention capacity, a small pressure drop and a long life. The materials according to the invention have high mechanical stability and can be used as filter material even at high flow rates. In comparison, filters having exclusively nanopores have large pressure drops and cannot be used at high flow rates.

### EXAMPLES

The mean layer thickness of the coatings was determined by aligning the fibers or the strut from the substrate along the observation direction in the scanning electron microscope (SEM) and then measuring the distance from the substrate to the outermost point at the polymer/air phase boundary by image analysis. The number-weighted mean value was calculated by individual measurement of 20 fibers.

The fractional efficiency corresponds to the proportion of the particles which are retained in the course of a measurement with the test material as filter. The fractional efficiency was determined using a cylindrical filter having a diameter of 50 mm and a height of 50 mm. The test aerosol used was an NaCl aerosol having 1 μm particle diameter. The volume flow rate was 600 l/h at 23° C.

The procedure was carried out in the air at ambient pressure (about 1000 mbar).

### Example 1

a) 26 g of an aqueous solution of a melamine-formaldehyde precondensate were introduced into a beaker at 20° C. The content of the solution was 16% by weight and the molar ratio of melamine to formaldehyde was from 1:1.5.
b) 4.3 g of a 100% strength by weight acetic acid were added with stirring at 20° C. A clear, low-viscosity mixture was obtained.
c) A foam comprising melamine-formaldehyde resin was immersed as a substrate in this mixture. The foam Basotect® from BASF was used. The foam was cylindrical (25 mm diameter, 40 mm high) and was completely covered by the mixture.
d) Curing was allowed to take place in the immersed state for 24 hours at 60° C.

e) Thereafter, the foam cylinder was removed from the beaker and the liquid (water and acetic acid) was removed by drying for 7 days at 20° C.

The mean layer thickness (number average) of the coating was 10 μm. The material obtained had a BET surface area of 123.2 m²/g. The uncoated substrate used in step c) had a BET surface area of less than 3 m²/g and a volume-weighted mean pore diameter of 162 μm, determined by mercury intrusion measurement according to DIN 66133. After coating and drying were complete, a volume-weighted mean pore diameter of 12.1 μm with a proportion of pores of 31.5% by volume in the range less than 1000 nm was determined for the porous material according to the invention by mercury intrusion measurement according to DIN 66133. The pore diameters of the nanoporous coating, determined by means of scanning electron microscopy, were in the range from 10 to 1000 nm.

### Example 2

a) 28.5 g of an aqueous solution of a melamine-formaldehyde precondensate were introduced into a beaker at 20° C. The content of the solution was 7.7% by weight and the molar ratio of melamine to formaldehyde was from 1:1.5.
b) 1.56 g of a 100% strength by weight acetic acid were added with stirring at 20° C. A clear, low-viscosity mixture was obtained.
c) A foam comprising melamine-formaldehyde resin was immersed as a substrate in this mixture. The foam Basotect® from BASF was used. The foam was cylindrical (25 mm diameter, 40 mm high) and was completely covered by the mixture.
d) Curing was allowed to take place in the immersed state for 24 hours at 60° C.
e) Thereafter, the foam cylinder was removed from the beaker and the liquid (water and acetic acid) was removed by drying for 7 days at 20° C.

The mean layer thickness (number average) of the coating was 5 μm. The material obtained had a BET surface area of 42 m²/g. The uncoated substrate used in step c) had a BET surface area of less than 3 m²/g and a volume-weighted mean pore diameter of 162 μm, determined by mercury intrusion measurement according to DIN 66133. After coating and drying were complete, a volume-weighted mean pore diameter of 50.8 μm with a proportion of pores of 3.3% by volume in the range less than 1000 nm was determined for the porous material according to the invention by mercury intrusion measurement according to DIN 66133. The pore diameters of the nanoporous coating, determined by means of scanning electron microscopy, were in the range from 10 to 800 nm.

### Example 3

a) 29 g of an aqueous solution of a melamine-formaldehyde precondensate were introduced into a beaker at 20° C. The content of the solution was 6% by weight and the molar ratio of melamine to formaldehyde was from 1:1.5.
b) 0.936 g of a 100% strength by weight formic acid was added with stirring at 20° C. A clear, low-viscosity mixture was obtained.
c) A foam comprising melamine-formaldehyde resin was immersed as a substrate in this mixture. The foam Basotect® from BASF was used. The foam was cylindrical (25 mm diameter, 40 mm high) and was completely covered by the mixture.
d) Curing was allowed to take place in the immersed state for 48 hours at 60° C.
e) Thereafter, the foam cylinder was removed from the beaker and the liquid (water and formic acid) was removed by drying for 7 days at 20° C.

The mean layer thickness (number average) of the coating was 2.5 μm. The material obtained had a BET surface area of 70.3 m²/g. The uncoated substrate used in step c) had a BET surface area of less than 3 m²/g and a volume-weighted mean pore diameter of 162 μm, determined by mercury intrusion measurement according to DIN 66133. The pore diameters of the nanoporous coating, determined by means of scanning electron microscopy, were in the range from 10 to 500 nm.

### Example 4

a) 28.7 g of an aqueous solution of a melamine-formaldehyde precondensate were introduced into a beaker at 20° C. The content of the solution was 6.5% by weight and the molar ratio of melamine to formaldehyde was 1:1.5.
b) 1.33 g of a 100% strength by weight acetic acid were added with stirring at 20° C. A clear, low-viscosity mixture was obtained.
c) A foam comprising melamine-formaldehyde resin was immersed as a substrate in this mixture. The Basotect® foam from BASF was used. The foam was cylindrical (25 mm diameter, 40 mm high) and was completely covered by the mixture.
d) Curing was allowed to take place in the immersed state for 48 hours at 60° C.
e) The foam cylinder was then removed from the beaker and the liquid (water and formic acid) was removed by drying for 7 days at 20° C.

The mean layer thickness (number average) of the coating was 2.5 μm. The material obtained had a BET surface area of 26 m²/g. The uncoated substrate used in step c) had a BET surface area of less than 3 m²/g and a volume-weighted mean pore diameter of 162 μm, determined by mercury intrusion measurement according to DIN 66133. After coating and drying were complete, a volume-weighted mean pore diameter of 80.1 μm with a proportion of pores of 3.7% by volume in the range less than 1000 nm was determined for the porous material according to the invention by mercury intrusion measurement according to DIN 66133. The pore diameters of the nanoporous coating, determined by means of scanning electron microscopy, were in the range from 10 to 500 nm.

The fractional efficiency of the uncoated substrate used in step c) was 32%. The fractional efficiency improved to 90% in the porous material according to the invention (after application of the coating and drying). At a flow rate of 19 800 l/h, the pressure drop was 87 Pa.

### Example 5

a) 0.5 g of an aqueous solution of a melamine-formaldehyde precondensate was introduced into a beaker at 20° C. The content of the solution was 6% by weight and the molar ratio of melamine to formaldehyde was 1:1.5.
b) 0.026 g of a 100% strength by weight acetic acid was added with stirring at 20° C. A clear, low-viscosity mixture was obtained.
c) A round piece of pulp having a thickness of 0.5 mm and a diameter of 25 mm was immersed in this mixture. The pulp was completely covered by the mixture.
d) Curing was allowed to take place in the immersed state for 24 hours at 60° C.

e) The pulp was then removed from the beaker and the liquid (water and acetic acid) was removed by drying for 7 days at 20° C.

The mean layer thickness (number average) of the coating was 1 μm. The porous material obtained had a BET surface area of 4.7 m²/g, whereas no BET determination could be carried out on the uncoated bulk owing to the small intrinsic surface area. The pore diameters of the nanoporous coating, determined by means of scanning electron microscopy, were in the range from 10 to 500 nm.

### Example 6

a) 7.1 g of an aqueous solution of a melamine-formaldehyde precondensate were introduced into a beaker at 20° C. The content of the solution was 6% by weight and the molar ratio of melamine to formaldehyde was 1:1.5.
b) 0.4 g of a 100% strength by weight acetic acid was added with stirring at 20° C. A clear, low-viscosity mixture was obtained.
c) A round nonwoven comprising fiberglass having a thickness of 10 mm and a diameter of 25 mm was immersed in this mixture. The nonwoven was completely covered by the mixture.
d) Curing was allowed to take place in the immersed state for 24 hours at 60° C.
e) The nonwoven was then removed from the beaker and the liquid (water and acetic acid) was removed by drying for 7 days at 20° C.

The mean layer thickness (number average) of the coating was 1 μm. The porous material obtained had a BET surface area of 12.2 m²/g, whereas no BET determination could be carried out on the uncoated fiberglass nonwoven owing to the small intrinsic surface area. The pore diameters of the nanoporous coating, determined by means of scanning electron microscopy, were in the range from 10 to 600 nm.

### Example 7

a) 30 mg of calcium carbonate were added to 0.9 g of a 100% strength by weight formic acid with stirring at 20° C. and a clear solution was obtained.
b) The solution obtained in a) was mixed at 20° C. with 29.1 g of an aqueous solution of a melamine-formaldehyde precondensate. The content of the latter solution was 5.8% by weight and the molar ratio of melamine to formaldehyde was 1:1.5.
c) A foam comprising melamine-formaldehyde resin was immersed as a substrate in this mixture. The Basotect® foam from BASF was used. The foam was cylindrical (25 mm diameter, 40 mm high) and was completely covered by the mixture.
d) Curing was allowed to take place in the immersed state for 24 hours at 60° C.
e) The liquid (water and formic acid) was then removed from the foam cylinder by drying for 7 days at 20° C.

The porous material obtained had a BET surface area of 35.2 m²/g. The uncoated substrate used in step c) had a BET surface area of less than 3 m²/g. The pore diameters of the nanoporous coating, determined by means of scanning electron microscopy, were in the range from 10 to 500 nm.

### Example 8

a) 140 mg of TDI were introduced into 7.9 g of 2-butanone at 20° C., and 65 mg of phloroglucinol and 2 μl of DBU as a catalyst were dissolved in 8 g of 2-butanone in two beakers in each case.
b) The two solutions were mixed. A clear, low-viscosity mixture was obtained.
c) A round nonwoven comprising polyethylene terephthalate (PET) of 3 mm thickness and 50 mm diameter was immersed as a substrate in this mixture. The supernatant was decanted. The nonwoven was completely covered by the mixture.
d) Curing was allowed to take place in the immersed state for 24 hours at room temperature.
e) The nonwoven was then removed from the beaker and the liquid (2-butanone) was removed by drying for 7 days at 20° C.

The porous material obtained had a BET surface area of 18.3 m²/g, whereas no BET determination could be carried out on the uncoated PET nonwoven owing to the small intrinsic surface area. The number average layer thickness of the coating was 0.5 μm. The pore diameters of the nanoporous coating, determined by means of scanning electron microscopy, were in the range from 10 to 600 nm.

### Example 9V

### Nanoporous Foam without Substrate

a) 120 mg of calcium carbonate were introduced into 2.7 g of a 100% strength by weight formic acid with stirring at 20° C. and a clear solution was obtained.
b) The solution obtained in a) was mixed at 20° C. with 27.3 g of an aqueous solution of a melamine-formaldehyde precondensate. The content of the latter solution was 17% by weight and the molar ratio of melamine to formaldehyde was 1:1.5.
c) Curing was allowed to take place for 24 hours at 60° C.
d) The liquid (water and formic acid) was then removed by drying for 7 days at 20° C.

The nanoporous foam obtained had the following properties based on mercury intrusion measurement according to DIN 66133: mean pore diameter 696 nm, porosity 83% by volume, proportion of pores smaller than 1000 nm: 70% by volume. The density was 281 g/dm³.

The examples show that porous materials according to the invention of different kinds could be produced in a simple manner. The filter efficiency, based on the fractional efficiency, could be considerably improved by the coating according to the invention. The porous materials according to the invention have a very small pressure drop at high flow rates of the gas stream to be filtered.

1. A porous material comprising a substrate based on at least one organic polymer A and a coating, where
i) the uncoated substrate based on the organic polymer A is macroporous,
ii) the surface of the macroporous substrate is coated with a polymer B based on reactive resins, and
iii) this coating with a polymer B is nanoporous and the mean diameter of the nanopores is not more than 1000 nm,
and recording materials being excepted.

2. A porous material comprising a substrate based on at least one organic polymer A and a coating, where
i) the substrate based on the at least one organic polymer A is macroporous and open-cell,
ii) the pore surface of the substrate is coated with at least one polymer B based on reactive resins, and
iii) the coating with at least one polymer B is nanoporous and the mean diameter of the nanopores is not more than 1000 nm and the mean layer thickness of the coating is less than the mean pore diameter of the uncoated substrate.

3. The porous material according to either of claims 1 and 2 claim 1, wherein the coating at least partly covers the pore surface of the substrate.

4. The porous material according to claim 1, wherein the coating has a mean layer thickness of from 0.01 to 10 μm.

5. The porous material according to claim 1, wherein at least 20% of the pore surface of the substrate is covered by the polymer B.

6. The porous material according to claim 1, wherein the uncoated substrate is an open-cell foam, a woven fabric, a nonwoven or a filter paper.

7. The porous material according to claim 1, wherein the polymer A of the uncoated substrate is composed of reacted amino-aldehyde resins, reacted phenol-aldehyde resins, polystyrene, polyvinyl chloride, polyurethanes, polyamides, polyesters, polyolefins, cellulose or fibers based on cellulose.

8. The porous material according to claim 1, wherein the uncoated substrate is selected from foams based on amino-aldehyde resins, phenol-aldehyde resins and polyurethanes.

9. The porous material according to claim 1, wherein the uncoated substrate is selected from woven fabrics or nonwovens based on polyester or cellulose.

10. The porous material according to claim 1, wherein the reactive resin is selected from amino-aldehyde resins, phenol-aldehyde resins and gel precursors based on isocyanates.

11. The porous material according to claim 1, wherein the reactive resin is selected from melamine-formaldehyde resins, urea-formaldehyde resins, melamine/urea-formaldehyde resins and gel precursors based on isocyanates and phenols.

12. A process for producing a porous material according to claim 1, wherein the reactive resin is brought into contact with the macroporous uncoated substrate and then cured to polymer B.

13. The process according to claim 12, comprising the following steps
a) the reactive resin is provided as a solution or dispersion in a liquid
b) a catalyst is added to the mixture obtained in the preceding step
c) the macroporous uncoated substrate is brought into contact with the mixture obtained in the preceding step
d) the mixture brought into contact with the substrate in the preceding step is cured in the presence of the substrate
e) the liquid present in the mixture is removed the steps being carried out in the sequence a-b-c-d-e or a-c-b-d-e.

14. The process according to claim 12, wherein the bringing into contact in step c) is effected by immersing the uncoated substrate in the mixture.

15. The use of a porous material according to claim 1 as a filter for gases or liquids.

16. A filter comprising a porous material according to claim 1.

17. A process for filtering gases or liquids, wherein the gas or the liquid is passed through a material according claim 1 or through a filter according to claim 16.

18. The porous material according to claim 2, wherein the coating at least partly covers the pore surface of the substrate.

19. The porous material according to claim 2, wherein the coating has a mean layer thickness of from 0.01 to 10 μm.

20. The porous material according to claim 3, wherein the coating has a mean layer thickness of from 0.01 to 10 μm.
